(19) United States
(12) Patent Application Publication
(10) Pub. No.: US 2010/0213943 A1
(43) Pub. Date: Aug. 26, 2010

(54) METHOD FOR ACCENTUATING SIGNAL FROM AHEAD OF THE BIT

(75) Inventors: Daniel T. Georgi, Houston, TX (US); Gregory B. Itskovich, Houston, TX (US); Michael B. Rabinovich, Houston, TX (US); Leonty A. Tabarovsky, Cypress, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/710,438

(22) Filed: Feb. 23, 2010

Related U.S. Application Data
(60) Provisional application No. 61/154,549, filed on Feb. 23, 2009.

(51) Int. Cl. G01V 3/18

(52) U.S. Cl. 324/339

(57) ABSTRACT

A method for estimating a property of a portion of an earth formation ahead of a borehole penetrating the formation, the method includes: conveying a logging tool through the borehole; receiving one or more first signals from a previous depth of the logging tool; constructing a model of the earth formation using the one or more first signals; predicting one or more second signals from the portion of the earth formation ahead of the borehole using the model; receiving one or more third signals from the portion of the earth formation ahead of the borehole; calculating a difference between the one or more third signals and the one or more second signals; and estimating the property from the difference.

### BACKGROUND OF THE INVENTION

1. Field of the Invention

The present invention relates to processing data obtained by a logging tool used to measure resistivity of an earth formation in a borehole. More particularly, the present invention relates to a method of determining the resistivity of the earth formation ahead of a drill bit drilling the borehole.

2. Description of the Related Art

Exploration and production of hydrocarbons generally requires drilling a borehole into the earth. The borehole can be used to gain access to depths of the earth for performing measurements related to the exploration and production.

Well logging is a technique used to perform the measurements in the borehole. In well logging, a logging tool is conveyed through the borehole. The logging tool includes those components used to perform the measurements. In one embodiment referred to as “logging-while-drilling” (LWD), the logging tool is coupled to a drill string having a drill bit at the distal end. Thus, the measurements can be performed while the borehole is being drilled or during a temporary halt in drilling.

One characteristic of the earth formation measured from within the borehole is resistivity. Resistivity can be measured using an induction logging tool.

In an induction logging tool, the resistivity of the earth formation is measured by generating eddy currents in the formation. In general, an induction logging tool includes at least one transmitter coil and at least one receiver coil separated and positioned along a longitudinal axis of the logging tool. Induction logging measures the resistivity of the formation by first inducing eddy currents to flow in the formation in response to a current flowing through the transmitter coil, which transmits electromagnetic energy into the formation. The eddy currents, in turn, generate electromagnetic signals, which are received by the at least one receiver coil. Variations in the magnitude of the eddy currents in response to variations in the resistivity of the earth formation are reflected as variations in the received electromagnetic signals. Thus, in general, the magnitude of the electromagnetic signals is indicative of the resistivity of the earth formation.

During drilling operations, it is very useful for a drilling operator or petroanalyst to be able to determine a type of material that is about to be drilled. That is, the drilling operator or petroanalyst would want to know significant features of the earth formation ahead of the drill bit about to be penetrated. Because of the limitations imposed by the borehole, such as a long cylindrical void, it is difficult to detect significant features before they are penetrated by the drill bit. Most antennas have electromagnetic radiation patterns that are dipole in nature. For a coaxial dipole, the electromagnetic radiation pattern behind the drill bit and ahead of the drill bit are similar and, hence, the sensitivity to features ahead of the drill bit is poor. Introducing transverse coils does not help with sensitivity ahead of the drill bit because the dipole moment is still centered about the longitudinal axis of the logging tool and, thus, provides data that is most sensitive to features to the side of the borehole.

Therefore, what are needed are techniques to detect features of an earth formation ahead of a drill bit drilling a borehole. Preferably, the techniques can be used with an induction logging instrument.

### BRIEF SUMMARY OF THE INVENTION

Disclosed is a method for estimating a property of a portion of an earth formation ahead of a borehole penetrating the formation, the method includes: conveying a logging tool through the borehole; receiving one or more first signals from a previous depth of the logging tool; constructing a model of the earth formation using the one or more first signals; predicting one or more second signals from the portion of the earth formation ahead of the borehole using the model; receiving one or more third signals from the portion of the earth formation ahead of the borehole; calculating a difference between the one or more third signals and the one or more second signals; and estimating the property from the difference.

Also disclosed is an apparatus for estimating a property of a portion of an earth formation ahead of a borehole penetrating the formation, the apparatus includes: a logging tool; and a processor in communication with the logging tool and configured to implement a method including: receiving one or more first signals from a previous depth of the logging tool; constructing a model of the earth formation using the one or more first signals; predicting one or more second signals from the portion of the earth formation ahead of the borehole using the model; receiving one or more third signals from the portion of the earth formation ahead of the borehole; calculating a difference between the one or more third signals and the predicted one or more second signals; and estimating the property from the difference.

Further disclosed is a machine-readable storage medium having machine-executable instructions for estimating a property of a portion of an earth formation ahead of a borehole penetrating the formation by implementing a method including: receiving one or more first signals from a previous depth of a logging tool; constructing a model of the earth formation using the one or more first signals; predicting one or more second signals from the portion of the earth formation ahead of the borehole using the model; receiving one or more third signals from the portion of the earth formation ahead of the borehole; calculating a difference between the one or more third signals and the one or more second signals; and estimating the property from the difference.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 depicts an exemplary embodiment of a logging instrument disposed in a borehole penetrating an earth formation;

FIG. 2 depicts aspects if processing electromagnetic signals to determine the resistivity of a formation ahead of a borehole; and

FIG. 3 presents one example of a method for estimating a property of the formation ahead of the borehole.

### DETAILED DESCRIPTION OF THE INVENTION

Disclosed are embodiments of techniques for detecting significant features of an earth formation ahead of a drill bit as the drill bit drills a borehole. The techniques, which include apparatus and method, call for measuring the resistivity or its inverse, conductivity (where conductivity=1/resistivity), of the earth formation ahead of the drill bit using an induction logging tool. The induction logging tool provides resistivity data at different depths as the drill bit penetrates the earth formation. Resistivity data from previous depths (i.e., uphole data) and resistivity data from shallow reaches at the current depth are used to construct a formation model. The formation model is then used to predict the signal that would be obtained from deep reaches at the current depth. Measurements at the deep reaches measure the resistivity of the earth formation ahead of the drill bit. The earth formation ahead of the drill bit (or, alternatively, ahead of the borehole) is referred to herein as the “forward formation.” The predicted signal is then subtracted from the current signal at the current depth to provide a difference signal. If the resistivity of the forward formation is identical to the previous resistivity measurement, then the difference signal will be zero or a residual of the system noise of the induction logging tool. If the difference signal is significantly different from zero, then the difference signal provides an indication that a characteristic of the earth formation is changing as the borehole is drilled deeper.

The difference signal can be an indication of the magnitude or proximity of an impending change in resistivity of the earth formation as the borehole is drilled deeper. A significant non-zero difference signal can indicate that the forward formation has a significant feature. Non-limiting examples of the significant feature include a fault, a salt diapir, an oil-water contact, a low resistivity layer, and a high resistivity layer.

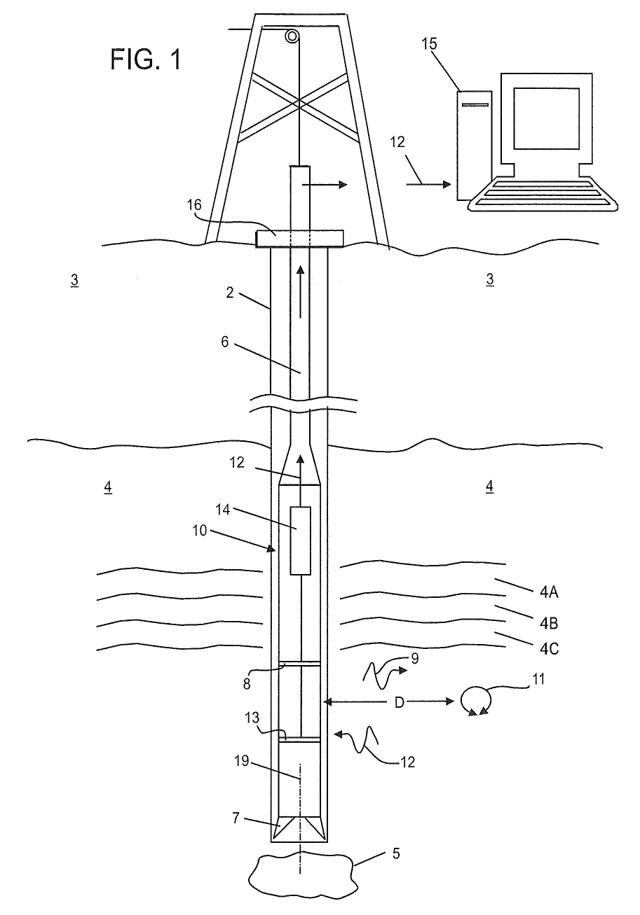

Reference may now be had to FIG. 1. FIG. 1 illustrates an exemplary embodiment of a logging tool 10 disposed in a borehole 2 penetrating the earth 3. The logging tool 10 has a longitudinal axis 19. Within the earth 3 is a formation 4 that can include formation layers 4A-4C. The logging tool 10 is coupled to a drill string 6 that includes a drill bit 7 disposed at the distal end of the drill string 6. A rotating device 16 rotates the drill string 6 causing the drill bit 7 to also rotate and drill the borehole 2. A forward formation 5 is that portion of the formation 4 that lies ahead of the drill bit 7. In general, the longitudinal axis 19 penetrates or leads to the forward formation 5.

The logging tool 10 is configured to perform induction logging measurements to determine resistivity (or conductivity) of the formation 4. As such, the logging tool 10 includes at least one transmitter coil 8 that is configured to transmit electromagnetic (EM) energy 9 into the formation 4. The transmitted EM energy 9 induces eddy currents 11 to form in the formation 4. The eddy currents 11, in turn, cause EM signals 12 to be received by at least one receiver coil 13 disposed at the logging tool 10. The EM signals 12 are related to the resistivity of portions of the formation 4 at which the eddy currents 11 are generated. Thus, by receiving and measuring the EM signals 12, the resistivity of those portions can be determined.

The distance D from the logging tool 10 to the portion of the formation 4 at which the eddy currents 11 are generated can be controlled by selecting at least one of magnitude and frequency of the transmitted EM energy 9. For reference purposes, the term “deep reaches” refers to the distance D that reaches at least to the forward formation 5. The term “shallow reaches” refers to the distance D that is less than the distance to the forward formation 5. Thus, resistivity measurements can be performed at shallow reaches and deep reaches in the formation 4. The term “deep reading” relates to signals obtained from the deep reaches. The term “shallow reading” relates to signals received from the shallow reaches.

Referring to FIG. 1, the logging tool 10 includes an electronic unit 14, which is configured to operate the coils 8 and 13 and/or receive and process the EM signals 12 received by the at least one receiver coil 13. In addition, the electronic unit 14 is configured to transmit the EM signals 12 and/or data related to the EM signals 12 to the surface of the earth 3 to a processing system 15 via a telemetry system. The EM signals 12 can be processed to determine resistivity by either the electronic unit 14 or the processing system 15 acting independently or jointly.

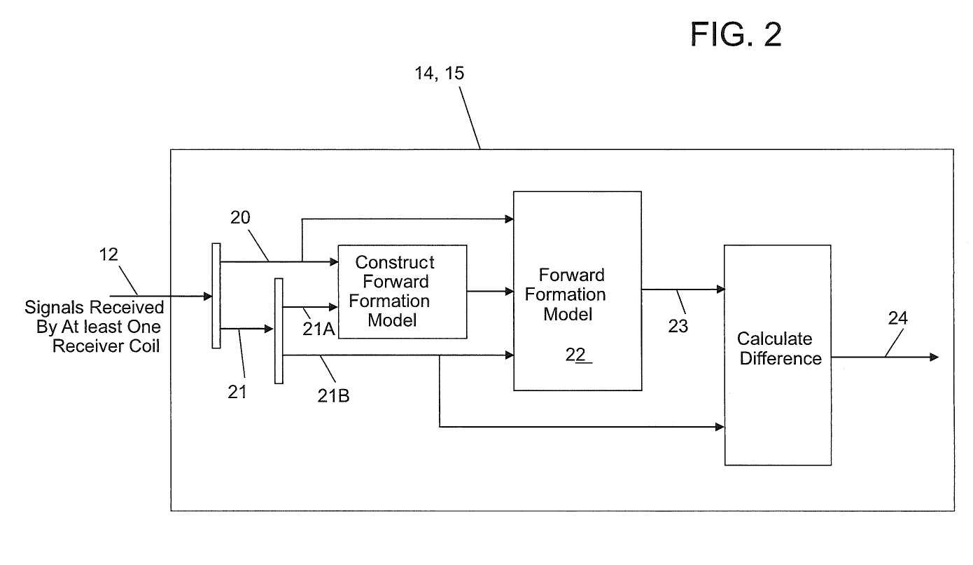

FIG. 2 depicts aspects of processing the EM signals 12 to determine the resistivity of the forward formation 5. The EM signals 12 received by the at least one receiver coil 13 are processed by electronic unit 14 and/or the processing system 15. The EM signals 12 are categorized as being an uphole signal 20 (i.e., resistivity data received uphole of the current position of the logging tool 10) or a current depth signal 21 (i.e., resistivity data received from the current position of the logging tool 10). The current depth signal 21 is further categorized as being a shallow reach signal 21A from the shallow reaches or a deep reach signal 21B from the deep reaches.

Referring to FIG. 2, uphole signals 20 and shallow reach signals 21A are used to create a forward formation model 22. The forward formation model 22 is used to predict the EM signal 12 from the forward formation 5 referred to as a predicted forward formation signal 23. That is, the predicted forward formation signal 23 is a prediction of the resistivity of the forward formation 5. Next, a difference signal 24 is calculated by taking a difference between the predicted forward formation signal 23 and the deep reaches signal 21B. The difference signal 24 that is zero, close to zero, or a residual of a magnitude of system noise indicates that the composition of the forward formation 5 is similar to or the same as the composition of the formation 4 that is being currently drilled. The difference signal 24 that is at least a certain selected magnitude indicates that the forward formation 5 has a significant feature. Various significant features can be correlated to various magnitudes of the difference signal 24.

The difference signal 24 can also be an indication of the magnitude and/or proximity of an impending change of resistivity in the forward formation 5. The magnitude of the resistivity change and distance to the resistivity change or the significant feature can be determined by inversion of the resistivity data derived from the EM signals 12 when multiple measurements of resistivity are performed at different distances D (see FIG. 1 for example of D).

The following technique can be used while drilling to separate changes in the EM signals 12 caused by the significant feature in the forward formation 5 from changes in the EM signals 12 caused by a different position of the logging tool 10 relative to objects, formation layers, and significant features already traversed by the borehole 2 and measured: (1) establish a formation structure (i.e., forward formation model 22) using a spatial window that includes some set of positions of the logging tool 10; (2) measure the EM signals 12 at the new set of positions, the EM signals 12 can be transient or continuous wave; (3) calculate the predicted forward formation signals 23 for the formation structure with the spatial window that includes the set of positions; (4) compare the predicted forward formation signals 23 from step 3 with the EM signals 12 obtained in step 2 to determine an amount of misfit; (5) if the amount of misfit is small, then the change in the EM signals 12 can be attributed to movement of the logging tool 10; and (6) if the amount of misfit is large, the change in the EM signals 12 can be attributed to a significant feature that should be incorporated in the model of step 1.

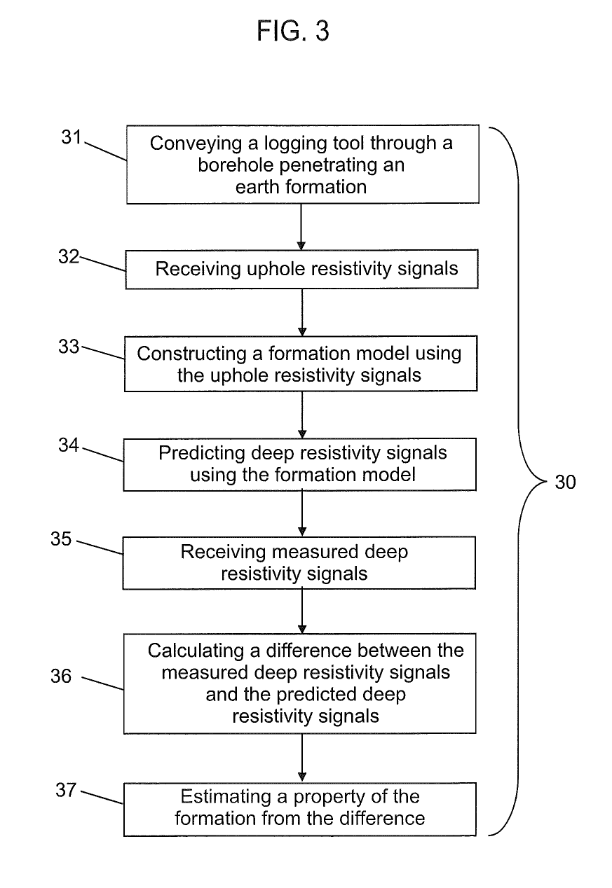

FIG. 3 presents one example of a method 30 for determining a property of a formation ahead of a borehole penetrating the formation. The method 30 calls for (step 31) conveying the logging tool 10 through the borehole 2. Further, the method 30 calls for (step 32) receiving the uphole resistivity signals 20 obtained from a previous depth of the logging tool 10. Further, the method 30 calls for (step 33) constructing the model 22 of the earth formation 4 using the uphole resistivity signals 20. Further, the method 30 calls for (step 34) predicting the deep resistivity signals 23 using the model 22. Further, the method 30 calls for (step 35) receiving the deep resistivity signals 21B at the current depth. Further, the method 30 calls for (step 36) calculating the difference 24 between the deep resistivity signals 21B and the predicted deep resistivity signals 23. Further, the method 30 calls for (step 37) estimating the property from the difference 24. The difference 24 may be compared to a setpoint. If the difference 24 is less than the setpoint, then the property can be estimated from the forward formation model 22. If the difference 24 is greater than the setpoint, then the difference 24 provides an indication or estimate that the property is different from what is predicted by the forward formation model 22. The different property can indicate a significant object or feature about to be drilled. In addition, the method 30 can include receiving the shallow resistivity signals 21A at the current depth and using these signals along with the uphole resistivity signals 20 to construct the model 22

The forward formation model 22 can be constructed downhole at the logging tool 10 (such as by the electronic unit 14), uphole at the surface of the earth 3 (such as by the processing system 15), or at some combination of downhole and uphole locations. Similarly, the comparison between the deep reading data and the data predicted by the forward formation model 22 can be performed downhole, uphole, or at some combination of downhole and uphole locations. When the comparison is made downhole, the difference 24 is transmitted to the surface of the earth 3 to a drill operator and/or petroanalyst. The difference 24, whether made downhole or uphole, can be transmitted to a drilling assembly that is programmed to execute specific actions based upon a value of the difference 24.

While in one disclosed embodiment, the uphole signals 20 and the shallow reach signals 21A are used to create the forward formation model 22, in another embodiment, data from drilling another borehole can be used alone to create the forward formation model 22 or the data in combination with the uphole signals 20 and the shallow reach signals 21A can be used to create the forward formation model 22.

In the embodiment of FIG. 1, the logging tool 10 is configured to perform induction measurements. Measurements of the resistivity (or its inverse conductivity) of the formation 4 may be performed using a variety of electromagnetic techniques such as alternating current (AC) techniques, direct current (DC) techniques, induction techniques, galvanic techniques, and transient electromagnetic techniques. The galvanic techniques generally use at least two electrodes for conducting a current through the formation 4. Voltage and current measurements may then be used to estimate the resistivity.

The term “signals” used herein relates to any type of signals used to measure a property of the formation 4. Non-limiting examples of the signals include electromagnetic signals, current signals, voltage signals, neutron signals, gamma ray signals, seismic signals and acoustic signals. The techniques disclosed herein for estimating a property of the earth formation 4 ahead of the borehole 2 are applicable to any type of signal used to measure a property of the formation 4.

The term “ahead of the borehole” used herein relates to a portion of the earth formation that extends beyond the end of the borehole. Alternatively stated, this term relates to that portion of the earth formation extending from a plane that is at the end of the borehole and perpendicular to the longitudinal axis 19 of the borehole. Alternatively stated, this term may also be described as a portion of the earth formation that is ahead of or in front of the drill bit drilling the borehole into the earth formation.

The techniques disclosed herein are applicable to wireline logging, logging-while-drilling (LWD), and measurements-while-drilling (MWD). Accordingly, the logging tool 10 may be conveyed in the borehole 2 by a wireline, a slickline, coiled tubing, a drill string, or any device conveyable into the borehole 2.

In support of the teachings herein, various analysis components may be used, including a digital and/or an analog system. For example, the electronic unit 14 or the processing system 15 can include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, power supply (e.g., at least one of a generator, a remote supply and a battery), vacuum supply, pressure supply, cooling component, heating component, motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first,” “second,” “third” and “fourth” are used to distinguish elements and are not used to denote a particular order.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for estimating a property of a portion of an earth formation ahead of a borehole penetrating the formation, the method comprising:
conveying a logging tool through the borehole;
receiving one or more first signals from a previous depth of the logging tool;
constructing a model of the earth formation using the one or more first signals;
predicting one or more second signals from the portion of the earth formation ahead of the borehole using the model;
receiving one or more third signals from the portion of the earth formation ahead of the borehole;
calculating a difference between the one or more third signals and the one or more second signals; and
estimating the property from the difference.

2. The method of claim 1, wherein the one or more first signals, the one or more second signals, and the one or more third signals are of a type comprising at least one selection from a group consisting of electromagnetic, current, voltage, neutron, gamma ray, seismic, and acoustic.

3. The method of claim 2, wherein the electromagnetic signals are selected from a group consisting of continuous wave and transient wave.

4. The method of claim 1, further comprising:
receiving current depth signals from the logging tool, the current depth signals comprising current depth shallow reading signals received from a portion of the earth formation at a first distance from the logging tool and current depth deep reading signals received from the portion of the earth formation ahead of the borehole at a second distance from the logging tool, wherein the second distance is greater than the first distance; and
using the current depth shallow reading signals to construct the model.

5. The method of claim 4, further comprising using the current depth deep reading signals to construct the model.

6. The method of claim 1, further comprising comparing the difference to a setpoint.

7. The method of claim 6, further comprising indicating a feature ahead of the drill bit when the difference exceeds the setpoint.

8. The method of claim 7, wherein the feature is selected from a group consisting of a fault, a diapir, an oil-water contact, a low resistivity layer and a high resistivity layer.

9. The method of claim 7, further comprising inverting the current depth signals to estimate the property of the feature and a distance from the logging tool to the feature.

10. The method of claim 1, wherein the logging instrument is configured for induction logging.

11. The method of claim 1, wherein the property is resistivity or conductivity or a combination thereof.

12. The method of claim 1, further comprising identifying a change in a measurement due to movement of the logging tool.

13. The method of claim 12, wherein identifying comprises:
constructing another model of the earth formation using the one or more first signals that are measured with at least two positions of the logging tool;
predicting other second signals from the earth formation ahead of the borehole for the at least two positions using the another model;
receiving other third signals at a current depth that are measured using the at least two positions of the logging tool, the other third signals being received from the portion of the earth formation ahead of the borehole;
calculating another difference between the other third signals and the predicted other second signals; and
identifying the other third signals as being due to movement of the logging tool if the another difference related to the at least two positions is less than another setpoint.

14. The method of claim 13, further comprising using fourth signals obtained at the current depth that are measured with the at least two positions of the logging tool to construct the other model, the fourth signals being received from a portion of the formation that is a distance from the logging tool that is less than the distance from the logging tool to ahead of the borehole.

15. The method of claim 1, wherein the one or more first signals are obtained from measurements from another borehole or a previously calculated database or a database comprising previously made measurements or some combination thereof.

16. An apparatus for estimating a property of a portion of an earth formation ahead of a borehole penetrating the formation, the apparatus comprising:
a logging tool; and
a processor in communication with the logging tool and configured to implement a method comprising:
receiving one or more first signals from a previous depth of the logging tool;
constructing a model of the earth formation using the one or more first signals;
predicting one or more second signals from the portion of the earth formation ahead of the borehole using the model;
receiving one or more third signals from the portion of the earth formation ahead of the borehole;
calculating a difference between the one or more third signals and the predicted one or more second signals; and
estimating the property from the difference.

17. The apparatus of claim 16, wherein the logging tool comprises at least one transmitter coil configured to transmit electromagnetic energy into the earth formation and at least one receiver coil configured to receive signals comprising electromagnetic energy from the earth formation.

18. The apparatus of claim 17, wherein the logging tool is configured to transmit at least one of a continuous electromagnetic wave and a transient electromagnetic wave.

19. The apparatus of claim 16, wherein the property is resistivity or conductivity or a combination thereof.

20. The apparatus of claim 16, wherein the processor is configured to invert the current depth signals to estimate the property of the portion of the earth formation ahead of the borehole and a distance from the logging tool to the portion.

21. The apparatus of claim 16, wherein the property is a feature selected from a group consisting of a fault, a diapir, an oil-water contact, a low resistivity layer and a high resistivity layer.

22. The apparatus of claim 16, wherein the logging tool is configured to be conveyed through the borehole by at least one selection from a group consisting of a wireline, a slickline, coiled tubing, and a drill string.

23. A machine-readable storage medium comprising machine-executable instructions for estimating a property of a portion of an earth formation ahead of a borehole penetrating the formation by implementing a method comprising:
receiving one or more first signals from a previous depth of a logging tool;
constructing a model of the earth formation using the one or more first signals;
predicting one or more second signals from the portion of the earth formation ahead of the borehole using the model;
receiving one or more third signals from the portion of the earth formation ahead of the borehole;
calculating a difference between the one or more third signals and the one or more second signals; and
estimating the property from the difference.
